(19) United States
(12) Patent Application Publication
(10) Pub. No.: US 2024/0035747 A1
(43) Pub. Date: Feb. 1, 2024

(54) DRYING OF FILTER MODULES AND FILTER HOUSINGS USING A FREQUENCY-GUIDED MICROWAVE PROCESS

(71) Applicant: Fricke und Mallah Microwave Technology GmbH, Peine (DE)

(72) Inventor: Marcel Mallah, Peine (DE)

(73) Assignee: Fricke und Mallah Microwave Technology GmbH, Peine (DE)

(21) Appl. No.: 18/020,668

(22) PCT Filed: Aug. 12, 2021
(86) PCT No.: PCT/DE2021/100693

§ 371 Date: May 8, 2023

(30) Foreign Application Priority Data
Aug. 12, 2020 (DE) 10 2020 121 262.3

(51) Int. Cl. F26B 3/347

(52) U.S. Cl. CPC F26B 3/347

(57) ABSTRACT

A microwave chamber for drying dialysis filter cartridges, cartridge filters and other closed filter systems. The microwave chamber has separate regions of high and low microwave absorption. The high energy absorption regions are in the central region of the filter where the bundle of hollow fibers or filter material is located. The low absorption areas are the microwave sensitive end regions of the filter module. To dry the wet filter module, the microwave frequency with the highest converted power is applied, and as the filter dries, the reflected microwave power is continuously determined and kept as low as possible by tracking the microwave frequency. The water is simultaneously discharged from the module. The process allows fast and gentle drying of filter cartridges and other closed filter units such as candle filters, and eliminates accidental overheating of the temperature-sensitive end sections of filter housings and modules with the seals and adhesives.

The invention relates to methods of manufacturing filter units containing a plurality of diaphragms or membranes, and to a method and apparatus for drying such filter units after they have been functionally tested.

### BACKGROUND OF THE INVENTION

Dialysis filter cartridges and their manufacture are known from EP 1 631 152 B1 and DE 10 2013 006 507 B4. The dialysis filter cartridges are required for the washing of the blood. In general, they contain a bundle of hollow fibers that provide a fluid path for the blood to flow through. The space between the outer surfaces of the hollow fibers and the cartridge housing provides a second fluid path through which the treatment or washing fluid flows. The wall of the hollow fiber separates the fluid paths and allows osmotic exchange of substances between the blood and the wash fluid. To make such a dialysis filter cartridge, the bundle of hollow fibers is inserted into a housing and the ends of the housing are sealed using synthetic resin or a sealing compound. This step is complicated because the sealing compound must not enter the hollow fibers and seal them, and the housing or cartridge must be absolutely leakproof. For quality assurance purposes, each filter cartridge must be individually tested for fluid path permeability and tightness in accordance with medical device manufacturing process and environmental quality assurance guidelines. Fluid path openness and filter cartridge tightness are tested with sterile water over a specified temperature range. The wet dialysis filter cartridge must then be dried. At present, the filter cartridge is dried by blowing hot air through the cartridge, with the aid of a microwave if necessary. This step is time consuming and complex because moisture can accumulate in areas that receive less air flow. In addition, the dipole moment of water molecules and the high surface tension of water make drying difficult. Microwave drying is problematic because microwave chambers have dead spots, which is why food is usually heated on a turntable. In addition, microwaves reflect off the walls of the chamber and can cancel each other out. Also, the seal of the filter cartridge or sealant must not be damaged by the microwave, e.g. by overheating.

The filtration described for blood washing is carried out osmotically (chemically) via several membranes or hollow fibers in the filter cartridge. In addition, there are many purely physical (mechanical) membrane separation processes which separate according to the principle of mechanical size exclusion. This means that all particles in the liquid that are larger than the membrane pores are retained by the membrane. The driving force in this separation process is the differential pressure between the inlet and outlet of the filter surface, which is usually between 0.1 and 20 bar and therefore usually takes place in a sealed housing. Microfiltration (pore size>0.1 micron) or ultrafiltration (pore size<0.1 micron) is widely used in the beverage and pharmaceutical industries, but also in other areas where particle-free fluids (e.g. oil) are required. The cartridge filter typically consists of a filter housing with one or more cartridges inserted through which the fluid flows from the outside to the inside. Closed, disposable cartridge filters are commonly used in the pharmaceutical industry. For quality assurance purposes, they must be pyrogen-free washed and leak tested after manufacture. A typical design of filter cartridges is wound cartridges, wound from a synthetic filament, e.g. propylene, or a filter medium of glass fiber, nonwoven, or a textile material. The advantages of such candle filters in a closed filtration system are low risk of contamination and no fluid loss. The individual cartridges must also be dried again after washing and testing, and the same problems as with dialysis cartridges must be overcome. They are usually vacuum dried, which requires considerable equipment and time. The alternative use of warm sterile air is also comparatively energy intensive and very expensive.

Further relevant prior art for the manufacture of dialysis filter cartridges is contained in DE 10 2007 035 583 A1, US 2012/0 234 745 A1, U.S. Pat. No. 5,556,591 A, JP H04-371 219 A. Thus, the prior art for manufacturing, functional testing and drying of closed filter systems represents a problem.

### SUMMARY OF THE INVENTION

The problem is solved by a method for drying closed filter systems, in particular after a functional testing or washing, comprising:
providing a microwave antenna chamber adapted to receive a filter module, wherein high and low microwave power zones are established in the chamber;
providing means for generating microwaves of a discrete frequency in the range of 2.3 to 2.6 GHz in said chamber;
providing means for detecting reflected microwave power;
introducing microwaves of a discrete frequency at which the highest power is converted in the liquid water, hereinafter also referred to as power dissipation;
passing air or gas through the filter module so that evaporated water is discharged from the system;
and further determining and adjusting the frequency of the microwave at which the highest power is lost in the water (power loss) until the closed filter system is dry.

The process according to the invention is particularly suitable for closed filter systems and disposable filters which, due to their quality, have to be washed again after manufacture or have to be individually tested for function and tightness for quality assurance purposes. Typical examples of such filter systems are dialysis filters for blood washing or candle filters for the production of particle or pyrogen-free pharmaceutical liquids and drugs. In addition, there are many areas of closed filter systems with increased quality and safety requirements that must not be damaged after functional testing or washing during or by drying.

In some embodiments of the method, the humidity of the gas exiting the filter module or filter system is also determined. In some embodiments of the method of the invention, the chamber is further configured such that regions of the filter having a bonding or seal are located in low microwave power zones. This serves to protect the bonding from damage.

In some preferred embodiments, the device for generating microwaves of a discrete frequency is a semiconductor microwave generator, i.e., a solid-state microwave generator instead of a magnetron and electron tubes.

In some embodiments, prior to drying the filter system, the frequency spectrum from 2.3 to 2.6 GHz is examined to determine at which discrete frequency the absorbed microwave power is greatest—i.e., the power converted in the water or the microwave energy introduced into the water hereinafter also referred to as power loss. This discrete frequency is then used as the starting point for drying. This frequency depends on the size of the filter, where the aforementioned spectrum applies to filters of approximately. 30 cm. Since the filter systems (closed cartridge filters and dialysis filter cartridges) contain bonding and sealing materials, attention must also be paid to the discrete frequencies at which these materials absorb. Their absorption will generally be outside the range of the various states of water in and on the fibers of the diaphragm or filter material, i.e., outside the range of 2.3 to 2.6 GHz, but this must be checked and adjusted if necessary.

According to the invention, the apparatus for drying closed filter systems such as filter cartridges and dialysis filters, comprises a chamber for receiving a filter system such as a dialysis filter cartridge;
means for generating microwaves of a discrete frequency in the range of 2.3 to 2.6 GHz; means for introducing microwaves into the chamber containing the filter system;
means for determining the reflected microwave power and the frequency at which the reflected power is lowest or the energy converted in the water is highest, for example the S-parameter; and
means for passing air or gas through the filter system.

The device for generating microwaves of a discrete frequency is preferably a semiconductor microwave generator. This may preferably further include means for determining the converted energy or reflected power at a discrete frequency.

In some preferred embodiments, the apparatus for drying filters further comprises means for feedback determining and tracking the frequency to a frequency at which the reflected power is minimal and at which no other damage to the filter module occurs. Preferably, the apparatus for drying closed filter systems and dialysis filter cartridges is configured to divide the chamber into high and low microwave power zones in a non-contact manner. In some embodiments, the chamber is divided into zones of high and low microwave power and is further designed such that after insertion of the closed filter system or filter module, the areas of bonding or sealing are located in zones of low microwave power.

In some embodiments, the apparatus for drying filter modules and dialysis filter cartridges may further include means for determining the moisture in the exhaust air or exhaust gas. Furthermore, there may preferably be means to determine the microwave energy absorbed in the chamber and optionally the scattering parameters for the power input.

The use of the device is particularly useful and preferred for dialysis filter cartridges, housings with filter cartridges and other closed filter systems sealed with synthetic resin and/or adhesive. The frequency-guided microwave treatment has the advantage that, at the starting frequency value, first the “free water” in the center of the filter cartridge or filter module is evaporated, then the water bound to the various surfaces is heated and evaporated, and finally, via the frequency shift, the water that has accumulated in the off-corners and niches of the filter housing. The frequency shift also changes the wave pattern in the chamber, in a sense searching for all free water in the housing or module. The bonding and sealing areas also contain water, but according to the invention, they are in areas or zones of lower microwave irradiation. These areas are reached but exposed to only a fraction of the power compared to conventional microwave methods. In addition, the heated gas passed through—usually dehumidified sterile compressed air—dries the areas with adhesives and seals. The process according to the invention and the use of the described device with frequency-guided microwave power thus dries closed filter systems such as dialysis filter cartridges and cartridge filters much more gently than before, so that the failure rate is lower. This advantage is striking. FIGS. 3 and 4 show an example of a dialysis filter cartridge with the change in resonant frequency and the introduced effective power as a function of the frequency setting, with the curves indicating the different drying states.

### BRIEF DESCRIPTION OF THE DRAWINGS

The drawings show:

FIG. 1 a representation of a dialysis filter cartridge and the power introduced by microwave in the water in the wet filter using the resonant frequency;

FIG. 2 a representation of a dialysis filter cartridge and the power introduced by microwave in the water in the dry filter at resonant frequency, where the microwave power is absorbed in the middle region with the wet fibers;

FIG. 3 Diagrams (A) of the course of the resonant frequency and (B) of the applied effective power in watts with the frequency adaptation over time;

FIG. 4 a diagram showing the time curve of the introduced (absorbed) power in percent and the reflected power in percent together with the percent humidity in the sight glass and the measured air temperature of the effluent in degrees Celsius;

FIG. 5 an illustration in front view (cut open) of the microwave chamber: (A) with and (B) without dialysis filter cartridge inserted, the sealed ends of the cartridge being partially protected from microwave power; (C) rear view of the microwave chamber with connection to the microwave generator, (D) sectional view of the microwave chamber with microwave antenna;

FIG. 6 a detailed view of the compressed air connection to the dialysis filter cartridge in the microwave chamber;

FIG. 7 a diagram of the scattering parameters S1,1 of the chamber (largest version of type A) with the wet dialysis filter cartridge inserted (start of process) over the frequency band (2.3-2.6 GHz) and the frequency band used (2.4-2.5 GHz), respectively;

FIG. 8 a diagram of the scattering parameters S 1,1 of the type A chamber when the dialysis filter cartridge is dry or at the end of the process;

FIG. 9 a diagram of the scattering parameters S1,1 of the chamber with wet dialysis filter cartridge of the smallest type B (start of process) over the frequency band (2.3-2.6 GHz) or the frequency band used;

FIG. 10 a diagram of the scattering parameters S1,1 of the type B chamber with a dry dialysis filter cartridge (at the end of the process);

FIG. 11 the distribution of the power converted in the water in the respective filters of type A (largest design) at different resonance frequencies;

FIG. 12 the distribution of the power converted in the water in the respective filters of type B (smallest design) at different resonance frequencies;

FIG. 13 Diagrams with a comparison of the S-parameters for a filter of type B (smallest design) and type A (largest design).

### DETAILED DESCRIPTION OF THE INVENTION

According to the invention, a microwave chamber is provided which has a resonant frequency at the lower limit of the relevant frequency band (2.3 to 2.6 GHz) when a closed filter module such as a dialysis filter cartridge or a candle filter is used in the wet state. In the cases shown, the relevant frequency band is between 2.4 to 2.5 GHz, corresponding to medium-sized filter modules with a diameter of 10 to 30 cm. For very large or very small filter modules, correspondingly higher or lower frequency bands are suitable. In the following, the device and the method are described as an example for filter systems with a hollow fiber module. However, the device and the method are equally suitable for modules with cartridge filters and other membrane filters.

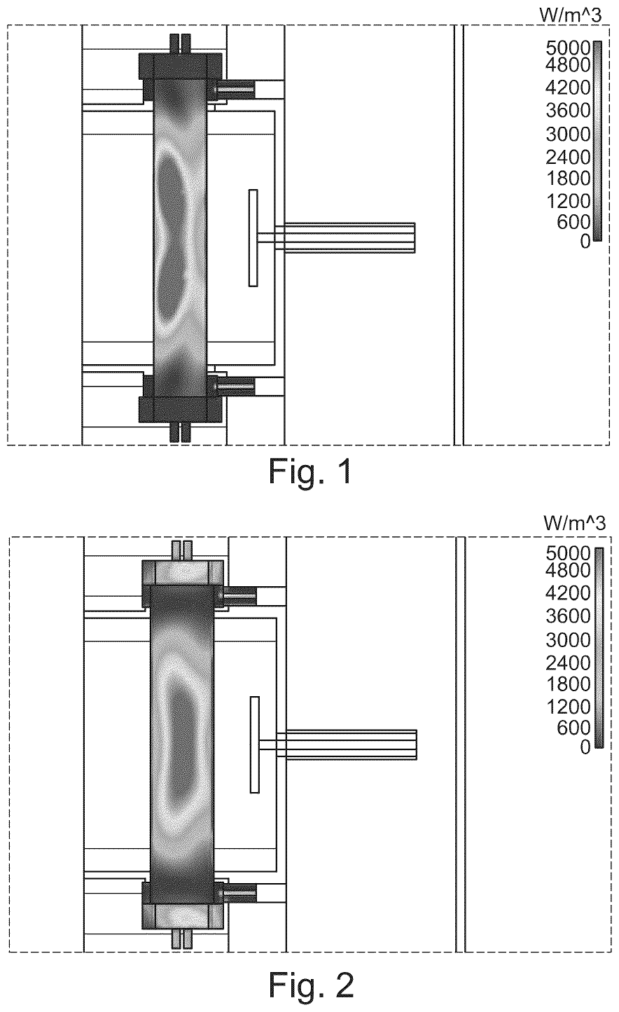

The aforementioned resonant frequency here represents the frequency at which the power reflection of the chamber is minimal and the power absorption occurs in the water; see FIG. 1. It is taken into account that the filters or the filter modules can have different diameters and thus also contain different amounts of water. The chamber is selected so that the largest filter unit, the largest filter module, the largest filter cartridge, which contains the most water and thus has the lowest resonant frequency in the chamber, is still within a usable frequency band of 2.4 GHz-2.5 GHz, i.e. just above 2.4 GHz

At the start of drying, the resonant frequency of the wet filter is determined by the equipment or microwave generator, preferably in a scan pass, and the determined resonant frequency for drying is taken as the start value for the microwave. This pre-run step can be omitted and is optional if the filter modules are manufactured with very tight tolerances and a constant frequency start value can be used for the microwave generator. Nevertheless, the determination of the start parameters can represent an optimization of the process.

If the start value for the microwave is fixed, the microwave generator begins to emit power at this frequency into the chamber. At the same time, it is continuously determined whether and how the resonance frequency changes, because water will evaporate due to the absorbed microwave power and be discharged from the filter module, the filter cartridge, by the air flow applied at the same time. The use of a warm through-air flow makes drying faster, but it is not mandatory and is very energy consuming. Sterile warm clean air is very expensive and laborious to produce. As the amount of water in the filter module or dialysis filter cartridge decreases, the resonance frequency increases. According to the invention, this change in resonance is detected by the equipment, for example on the basis of microwave reflection, and the microwave frequency emitted is tracked or increased accordingly. Thus, the generator follows the frequency change by adjusting the frequency to match the absorbed power. This minimizes the reflected power and maximizes the power input to the water.

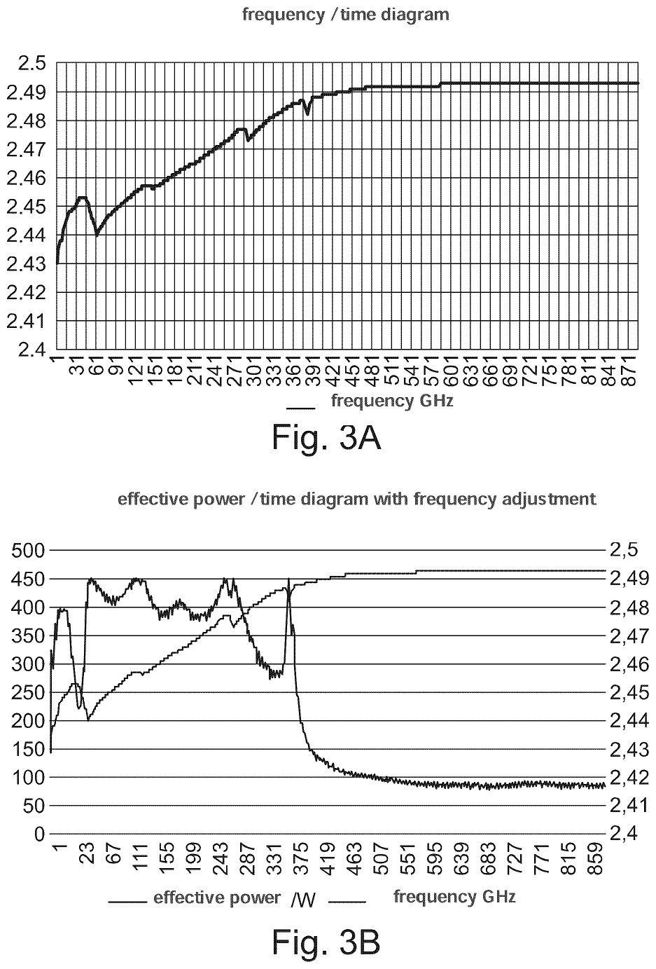

The microwave generator follows the resonant frequency change by adjusting the frequency of the output power so that the absorbed power is maximized; see FIG. 3. This minimizes the reflected power and maximizes the power input to the water. At a point, the frequency change stagnates because most of the water has been discharged (see FIG. 3, after about 460 seconds). There are then only appreciable quantities of water in the shielded areas with the sealing material or in the bonding of the filter module (filter cartridge, cartridge filter, disposable filter).

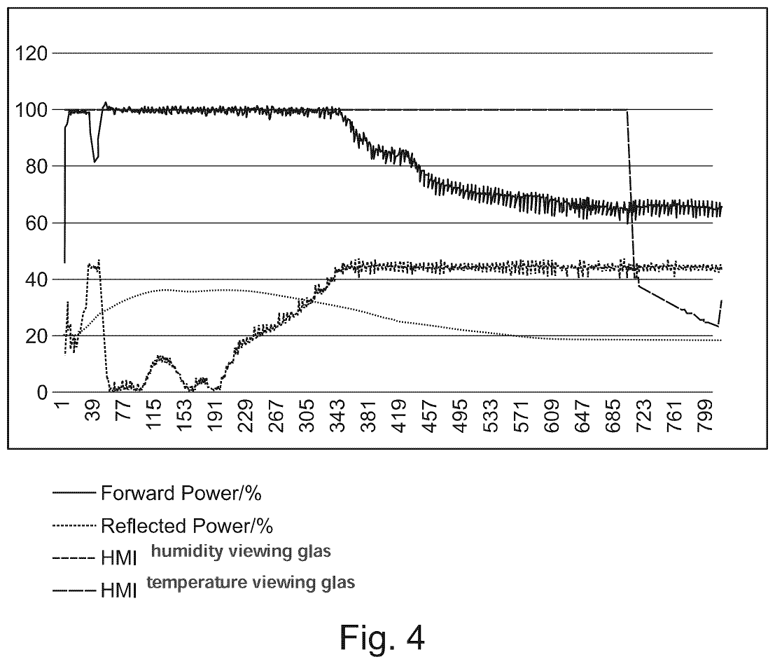

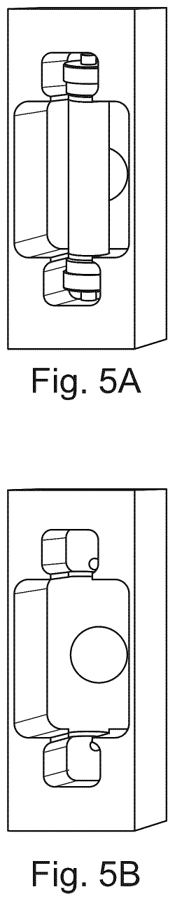

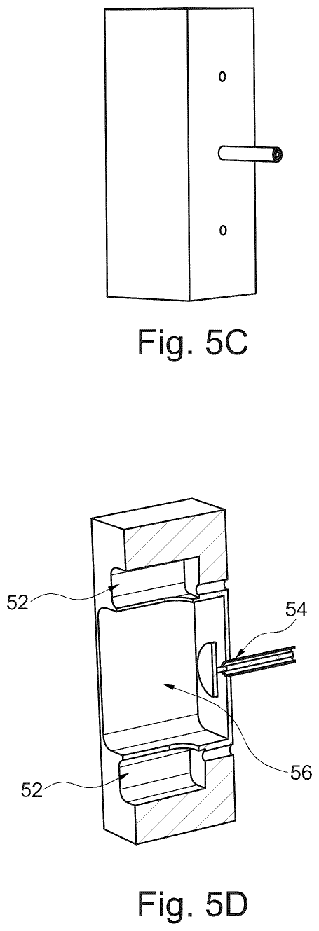

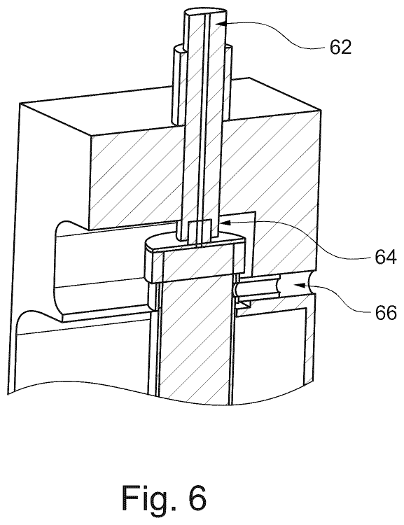

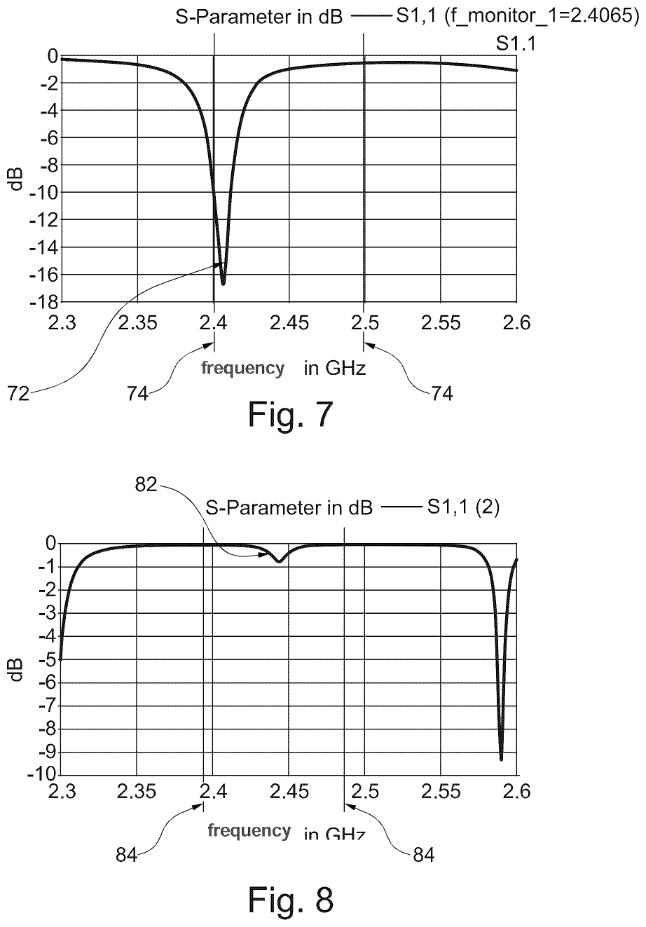

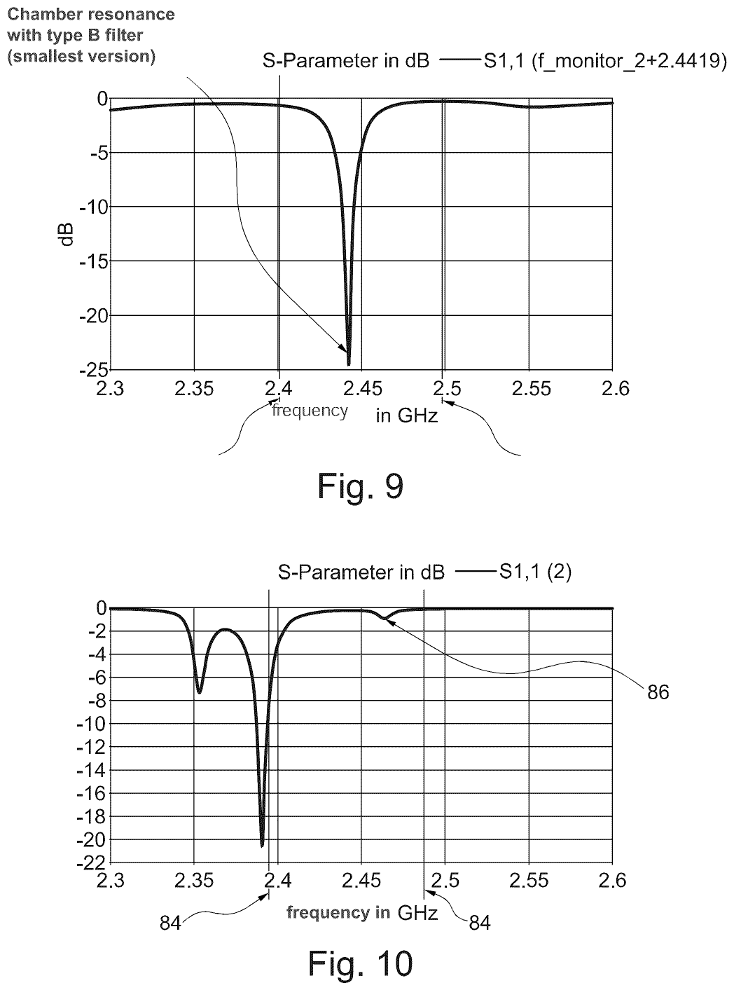

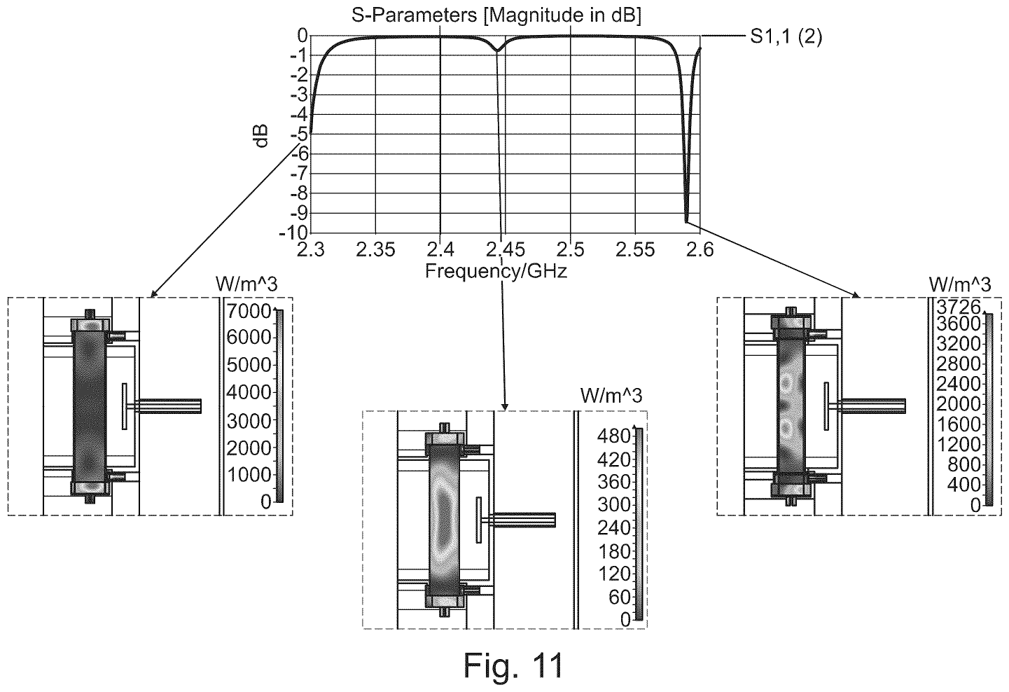

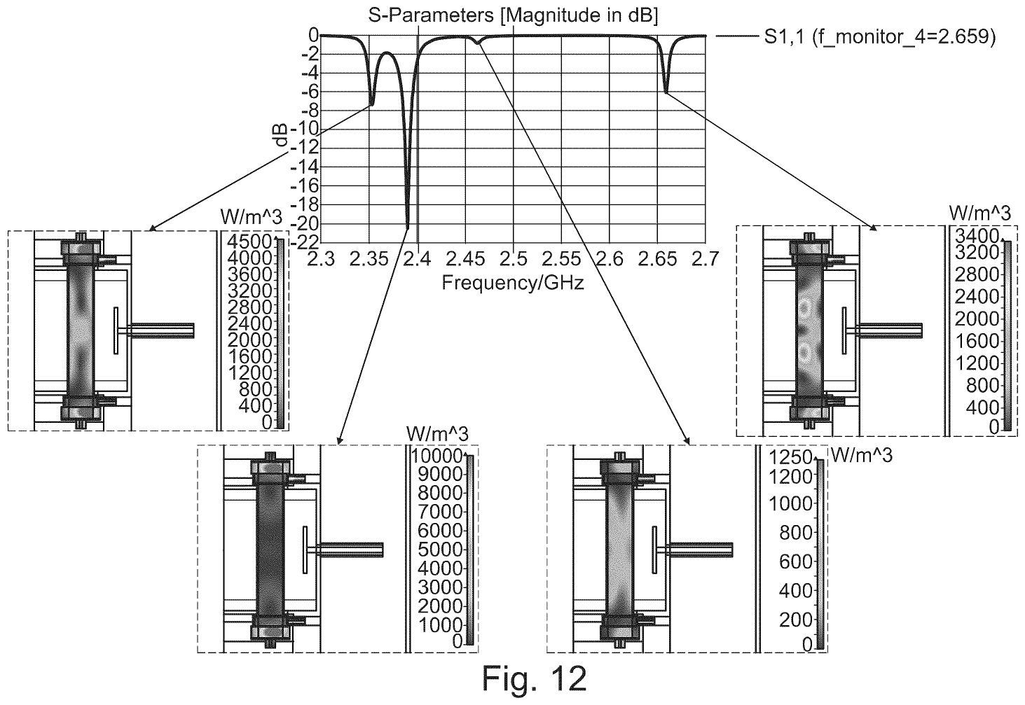

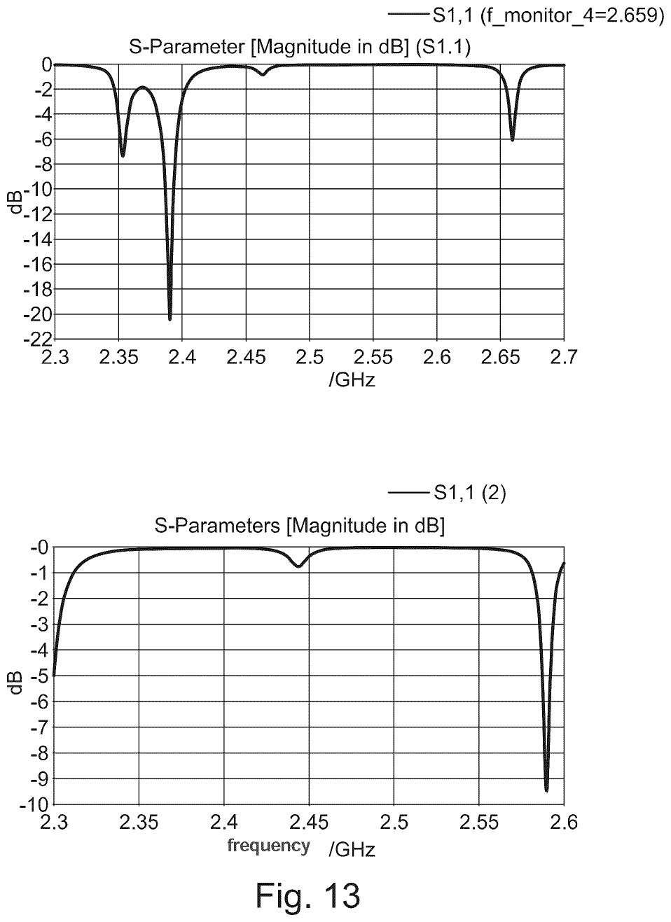

Due to the further use of microwaves, in the absence of water in the filter or in the bundle of hollow fibers, the sealing and adhesive mass and the water contained therein are now heated. For the same filter in dry version, the chamber shows the picture shown in FIG. 2. The chamber is selected so that the resonances at which microwave power significantly couples into the areas of the filter to be protected are outside the ISM band of 2.4 to 2.5 GHz and thus cannot be inadvertently approached by the generators (see FIG. 11 for dry dialysis filter cartridges of type A—largest design). The middle figure shows the rest of the resonance with coupling into the middle region. This is the mode shown in the last half of the power/time diagram of FIG. 3B. The implementation of the filters in the simulation may differ minimally from the real filter. However, the principle remains untouched. The middle figure shows that some power is coupled into the sealing and bonding points to be protected when the water is displaced from the middle region. However, this power is not very high due to the low matching of less than −1 dB, since the microwave generator automatically controls its output power. In addition, the ratio of the power between the middle area and the ends is different by more than a factor of 2, so this is tolerated by the glue joints, and moreover, the moisture removal from the glue joints is accelerated. By further shielding, only a small portion of the power reaches this area. The use of warm air significantly shortens the final drying step, as this expels the remaining water from the shielded seal very efficiently. The process is completed as soon as the measured humidity in the exhaust air falls below a target value; see FIG. 4.

The chamber is designed or shaped in such a way that the resonance of the chamber when power is applied to the water in the case of a type A filter (largest design) is still within the usable frequency band when wet, and that the resonance of the chamber when power is applied to the areas to be protected in the case of a type B filter (smallest design)—i.e. to the areas with the bonding and sealing compound—is outside the usable frequency band when dry.

The process is specifically designed for drying filters with emphasis on dialysis filters and cartridge filters. Due to the variable emitted microwave frequency, the process requires that the microwaves be generated by semiconductors or solid-state technology. Magnetrons can only generate and emit microwaves of a fixed certain frequency or a chaotic frequency. By using solid-state microwave generators that allow very precise power and frequency adjustment, a controllable drying process can be achieved according to the invention. The entire drying process can be achieved entirely by microwaves without additional drying by hot air. Power adjustment is not possible with conventional magnetron-based microwave technology.

The drying application can have a modular design so that the application can be scaled up in parallel and customized. The filter modules (dialysis filter and cartridge filter cartridges) can be inserted into the drying chambers manually or fully automatically by means of a robot, as is already common practice at present.

A microwave chamber with non-contact separation of the zones corresponding to the functionally different areas of the filter cartridges and modules is presented. The drying chamber offers the advantage that it can be loaded with filter cartridges to be dried via a door. The skilled person will recognize that the loading can take place from the front, from the rear, from the side or also from above or below. Preferred is a chamber that allows the use of robots for the loading of the drying chamber. The separation of the zones corresponds to the areas of high and low power absorption. In the case of dialysis filter cartridges, these contain a particularly large amount of water after leak testing in the area of the bundle of hollow fibers. In contrast, the areas with the synthetic resin or sealing compound must be protected from excessive microwave power. The same applies to closed chambers with candle filters. Furthermore, the chamber requires a connection for discharging the water. The L-power introduced by the microwave generator and converted in the water occurs primarily in the middle area of the filter, where most of the water is present. The design or non-contact separation of the zones eliminates the need for protective caps for the areas to be protected on the filter modules. This increases the reproducibility of drying and greatly simplifies the drying process. Microwave drying is made even safer by the fact that the resonances with losses in the zones to be protected are outside the ISM band. Furthermore, it is used that the resonance of the chamber changes due to the water loss. This fact, and by measuring and tracking the resonance, microwave power can be introduced into the water at low reflection. The water is also bound differently in the filter material or on the fibers of a dialysis filter cartridge: as “free” water or absorbed on a surface. These different states cause different resonance frequencies or peaks in the curve with the resonance frequency. The use of a gas, preferably compressed air, for a discharge of the evaporated water accelerates the drying process. This actively dries the microwave-sensitive areas containing sealing and adhesive compounds.

An apparatus for drying closed filter systems with a hollow fiber or cartridge filter module has been described, comprising a microwave chamber which can be equipped with a filter cartridge or filter module. The microwave chamber is characterized by dividing zones of high and low microwave absorption without contact. The zone of high absorbed power corresponds to the central area of the filter module, where the bundle of hollow fibers or the filter material is located. The zones of low microwave absorption correspond with the more microwave-sensitive end regions of the filter cartridge, where further seals and bonding are located. To dry the wet filter module, the microwave frequency with the highest absorbed power is first determined, then microwave power is introduced at that frequency, and as the filter module dries, the reflected microwave power is continuously determined by the equipment and kept as low as possible by tracking the microwave frequency. The water is also discharged from the filter with a stream of air or gas. The process requires a generator whose frequency can be adjusted—in practice, a microwave generator based on solid-state technology. This allows for faster and more gentle drying. In particular, it avoids rejects due to accidental overheating of temperature-sensitive areas of the filter system and on seals and bonds.

### LIST OF REFERENCE NUMBERS

10 Dialysis filter cartridge
12 Compressed air connection (supply and exhaust air)
14 Filter cartridge connection (blood, washing liquid)
16 Sealing, bonding
52 Sections with low microwave power in the microwave band used
54 Antenna with external connection
56 Microwave chamber
58 Zone with low microwave exposure
62 External cartridge connection
64 Vertically adjustable compressed air port (top) to secure filter cartridge and seal against cold and hot compressed air;
66 Lateral compressed air port for cold and hot compressed air, including seal, and for alignment/centering of the filter cartridge;
72 Resonance of the chamber with wet filter of type A (largest version).
74 Useable frequency band
76 Resonance of the chamber with wet filter type B (smallest version)
82 Resonance of the chamber with dry filter type A
84 Useable frequency band
86 Resonance of the chamber with dry filter type B

1. A method for drying closed filter systems after washing or functional testing, comprising the steps of:
providing a chamber with a microwave antenna adapted to receive a filter module, wherein zones of high and low microwave power are established in the chamber;
providing means for generating microwaves of a discrete frequency in the range of 2.3 to 2.6 GHz in the chamber;
providing means for detecting the reflected microwave power;
introducing microwaves of a discrete frequency at which the highest absorption of power occurs;
passing air or gas through the filter so that evaporated water is removed from the enclosure; and
further determining and re-adjusting the frequency of the microwave at which the highest energy input to the pre-existing water occurs until the filter module is dry.

2. The method of claim 1, wherein the humidity of the gas exiting the filter module is determined.

3. The method of claim 1, wherein the chamber is designed such that regions of the filter module having a bond or seal are located in low microwave power zones.

4. The method of claim 1, wherein the device for generating microwaves of a discrete frequency is a semiconductor microwave generator.

5. The method of claim 1, wherein the frequency spectrum from 2.3 to 2.6 GHz is examined to determine at which discrete frequency the microwave power absorbed by the water is greatest.

6. The method according to claims of claim 1,
wherein the closed filter system is selected from hollow fiber modules for plasmapheresis and blood washing, candle filters for particle and sterile filtration, disposable filter modules.

7. The method of claim 1, using an apparatus for drying closed filter systems, the apparatus comprising:
a chamber for receiving a filter module;
means for generating microwaves of a discrete frequency in the range of 2.3 to 2.6 GHz;
means for introducing microwaves into the chamber containing the filter module; and
means for determining the reflected microwave power and the frequency at which the reflected power is lowest; and means for passing air or gas through the filter module.

8. The method of claim 7, wherein the drying apparatus comprises means for feedback determining and tracking the frequency to a frequency at which the reflected power is minimal.

9. The method of claim 7, wherein the chamber is divided into high and low microwave power zones in a non-contact manner.

10. The method of claim 7, wherein the chamber is divided into high and low microwave power zones and is designed such that, after insertion of the filter module, the areas of bonding or sealing are in low microwave power zones.

11. The method of claim 7, wherein the apparatus comprises means for determining the humidity of the exhaust air or exhaust gas.

12. The method of claim 7, wherein the means for generating microwaves of a discrete frequency is a semiconductor microwave generator.

13. The method of claim 7, wherein the means for generating microwaves of a discrete frequency integrally comprises means for determining absorbed power or reflected power at a discrete frequency.

14. The method of claim 7, wherein the microwave energy absorbed in the chamber is determined based on a scattering parameter.

15. The method of claim 7, wherein the filter module is sealed with synthetic resin and/or adhesive.
